(19) United States
(12) Patent Application Publication
(10) Pub. No.: US 2010/0209896 A1
(43) Pub. Date: Aug. 19, 2010

(54) VIRTUAL MANIPULATIVES TO FACILITATE LEARNING

(76) Inventors: Mickelle Weary, Kirkland, WA (US); Rebecca M. Lewis, Tacoma, WA (US); Laura Koch, Seattle, WA (US); Jennifer A. Seery, Renton, WA (US); Catherine Twomey Fosnot, New London, CT (US); Aja M. Hammerly, Seattle, WA (US); Neil Smith, Redmond, WA (US); Nigel J. Green, Bellevue, WA (US); Roy Leban, Redmond, WA (US); Slavi Marinov Marinov, Varna (BG); Valentin Mihov, Sofia (BG); Christopher M. Franklin, Bellevue, WA (US); Cristopher Cook, Seattle, WA (US); Nathan Brutzman, Seattle, WA (US); Lou Gray, Bellevue, WA (US); Benjamin W. Slivka, Clyde Hill, WA (US); Lorenzo Pasqualis, Carnation, WA (US); Daniel R. Kerns, Mercer Island, WA (US); Tami Caryl Borowick, Issaquah, WA (US); Ken Curspe, Seattle, WA (US); Ronald Anthony Kornfeld, Seattle, WA (US); Sarah Daniels, Bellevue, WA (US)

Correspondence Address: HAHN AND MOODLEY, LLP, 548 Market Street, San Francisco, CA, 94104, US

(21) Appl. No.: 12/691,884

(22) Filed: Jan. 22, 2010

Related U.S. Application Data
(60) Provisional application No. 61/146,630, filed on Jan. 22, 2009.

(51) Int. Cl. G09B 5/00; G06F 7/42; G09B 19/02

(52) U.S. Cl. 434/201; 708/162; 708/670; 708/204

(57) ABSTRACT

Embodiments of the invention disclose a virtual manipulative to facilitate math learning. The virtual manipulative comprises a user interface to progressively form one on more columns to hold partial sums or number decompositions to assist a learner in computing a sum.

This application claims the benefit of priority to U.S. Provisional Patent Application 61/146,630 which was filed Jan. 22, 2009

### FIELD

Embodiments of the present invention relate generally to software and systems designed for teaching purposes.

### BACKGROUND OF THE INVENTION

Concrete or physical manipulatives such as blocks, math racks, counter, etc., are used to facilitate learning, especially in the field of mathematics. Virtual manipulatives refer to digital “objects” that are the digital or virtual counterpart of concrete manipulatives. Virtual manipulatives may be manipulated, e.g., with a pointing device such as a mouse during learning activities.

### BRIEF DESCRIPTION OF THE DRAWINGS

FIGS. 1-5 illustrate virtual manipulatives in accordance with embodiments of the invention; and

FIG. 6 shows an example of hardware that may be used to generate the virtual manipulatives in accordance with one embodiment of the invention

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrases “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

Embodiments of the present invention disclose several virtual manipulatives to facilitate learning. Each of the manipulatives is generated by a computer system, and is displayed on a display screen. Advantageously, each virtual manipulative represents a User Interface (UI) particularly suited on improve math learning.

In one embodiment, there is provided a virtual manipulative called a “human calculator” designed to simplify the process of adding a list of numbers by having a learner progressively revise the list of numbers (“addends”). Each revision of the list of numbers is the numerical equivalent of the original list but with addends from the original list modified or transformed to facilitate easier addition. In one embodiment, the addends from the original list may be modified by decomposition or by aggregation. With decomposition, the idea is to split or decompose a number into components that are easier to add. For example consider the problem 53+16. In this case, it may be easier to split or decompose the number 53 to form the numbers (addends) 50 and 3 and to decompose the number 16 into the numbers 10 and 6. Thus, the problem number 53+16 may be represented as the problem 50+3+10+6. By combination, the idea is to combine or aggregate numbers to form partial sums that once again are easier to add. For example 13 and 7 in the original list may be combined or aggregated to form 20, whereas 6 and 4 in the original list may be aggregated to form 10. Multiples of ten are an example of easier numbers to add.

The thus formed revised list of numbers may in turn be further revised in like fashion to form another revised list. Revised lists may thus be progressively formed until the learner chooses to enter a total for all the addends in the original list.

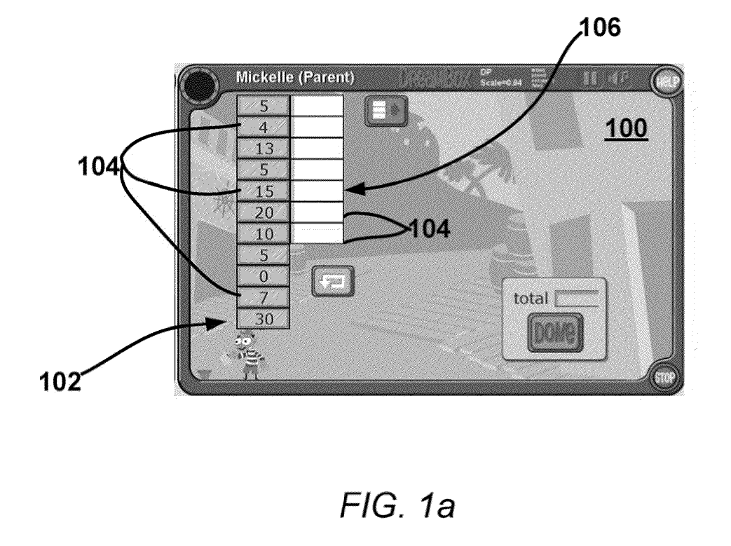

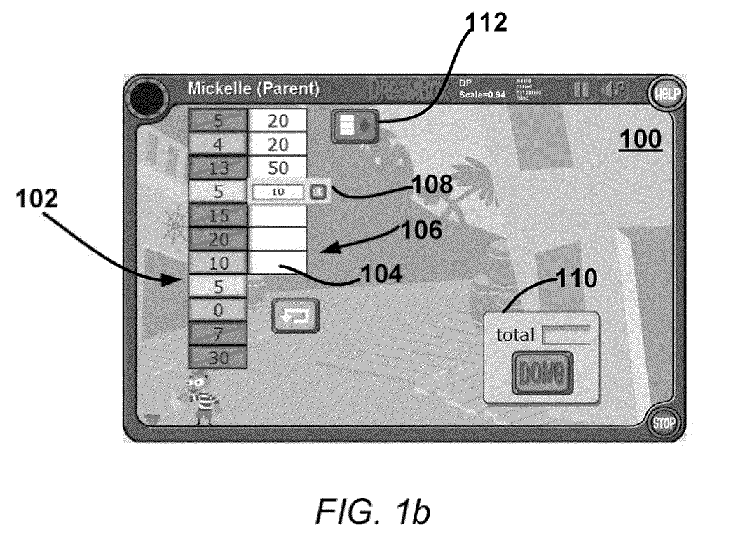

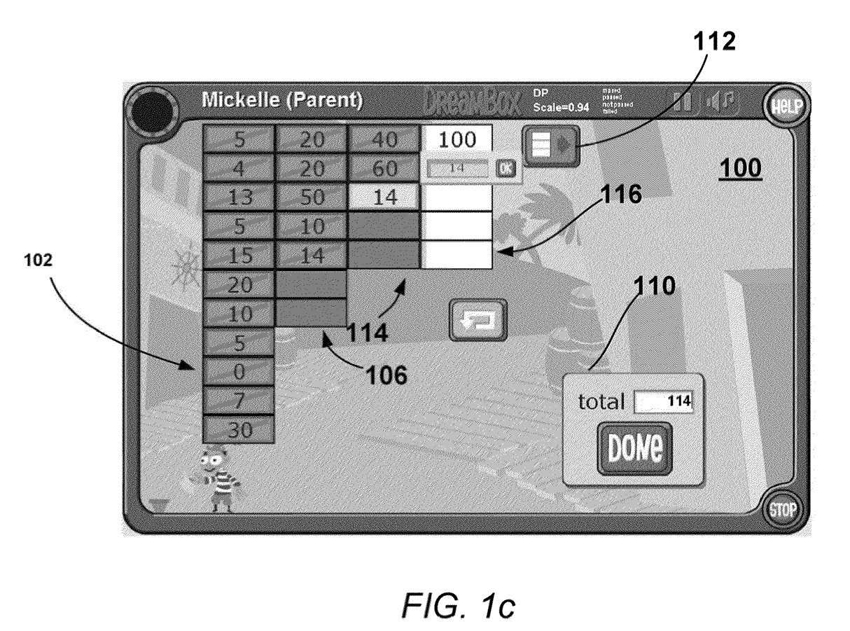

FIG. 1a illustrates a human calculator virtual manipulative 100, in accordance with one embodiment of the invention. The manipulative 100, displays a list of addends for a learner to add. This list is presented vertically as a column 102 comprising a number of boxes 104, each holding a single number. Immediately adjacent to the column 102 and to the right thereof is a first empty column 106 which includes a number of empty boxes 104. In computing a total for the list of addends in column 102, the learner is expected to form one or more revised addend lists containing addends that are easier to add. For example, the learner may decide to combine the numbers 5 and 15 from the original list shown in column 102 thereby to form the number 20 shown in the first box in the column 106 (see FIG. 1b). Likewise, the learner may combine the number 13 and number 7 to form the number 20 shown in the second box in the column 106. Finally, the number 20 may be combined with the number 30 thereby to form the number 50 shown in the third box in column 106. Thus, the learner is able to build a revised list of addends in the column 106. The above example shows how addends from the original list may be combined. However, addends from the original list may equally be decomposed as explained above.

In one embodiment, the manipulative 100 is designed to facilitate the process of creating the revised addend lists. Thus, the manipulative 100 advantageously incorporates a selection mechanism whereby addends being combined are visually highlighted to bring them into focus in the mind of the learner. Such visual highlighting of the addends when forming partial sums in the manner described above may reduce errors. With the virtual manipulative 100, all the boxes 104 in the column 102 are initially a first color, e.g. green. Boxes 104 with numbers to be added to form a partial sum may be selected with the selection mechanism. This causes the selected boxes to be displayed in a different color, for example, the color yellow shown in FIG. 1b of the drawings. In FIG. 1b, two boxes with the number “5” are highlighted in yellow signifying that these numbers are being added to form the partial sum “10” which is then entered in a box 104 in column 106. The learner then selects an “okay” button 108 to complete input of the partial sum “10”. It will be seen that the revised list of addends shown in the column 106 now only includes numbers that are multiples of the number 10. Thus, the revised list of addends is easier to add than the original list.

In one embodiment, numbers in a list that have already been combined or decomposed are rendered non-selectable by the selection tool. Additionally, these numbers may be displayed in a different color or highlighted in some fashion to denote that they have already been combined or decomposed. For example, as is shown in FIG. 1b, the numbers already combined or decomposed are shown in boxes colored gray.

The virtual manipulative 100 also includes a box 110 for receiving input corresponding to a total for all the numbers in the original list. Having formed the revised list of addends in the column 106, in the manner described above, the learner may decide that the revised list is simple enough to add in its entirety. In this case, the learner will add all the addends in the revised list to form a total which is then entered in the box 110.

In one embodiment, the manipulative 100 also includes a control 112 to create a new empty column such as the column 106. The control 112 is designed to be activated, e.g.,. using a pointing device such as a mouse, by a learner who after creating a revised list A in the manner described wishes to create a further revised list B by decomposing or combining addends in the revised list A. Each new empty column is positioned adjacent to a previous column. For a proper understanding of the use of the control 112 consider the revised list shown in column 106 in FIG. 1c. As was described above, the addends in the revised list shown in column 106 were formed by combining addends from the original list shown in column 102. The learner may decide that the revised list in column 106 requires further revision. Thus, the learner activates the control 112, e.g. by clicking on the control with a pointing device such as a mouser'. This action causes the addition of a new column 114, as can be seen in FIG. 1c. The boxes in the column 114 are initially empty, i.e., they do not hold any numeric values. The learner populates the boxes in the new column 114 by aggregating or decomposing addends from the revised list in the column 106, in the manner described above. Having completed the revised list in the column 114, the learner has the option of forming the total of the addends in the column 114 and entering same in the box 110. Alternatively, the learner may activate the control 112 once more to obtain another column 116, wherein a further revised list may be formed based on the revised list in the column 114. The process of adding new columns using the control may be performed several times, until the learner decides to enter the final sun into the box 110.

It is important to note that in the process of aggregating addends to form partial sums, the manipulative 100 allows two or more addends to be so aggregated. Further, in one embodiment the manipulative 100 corrects a learner's input only when the “done” button in the box 110 is activated or when the control 112 is activated to generate a new column. In the latter case the correction relates to correcting the partial sums.

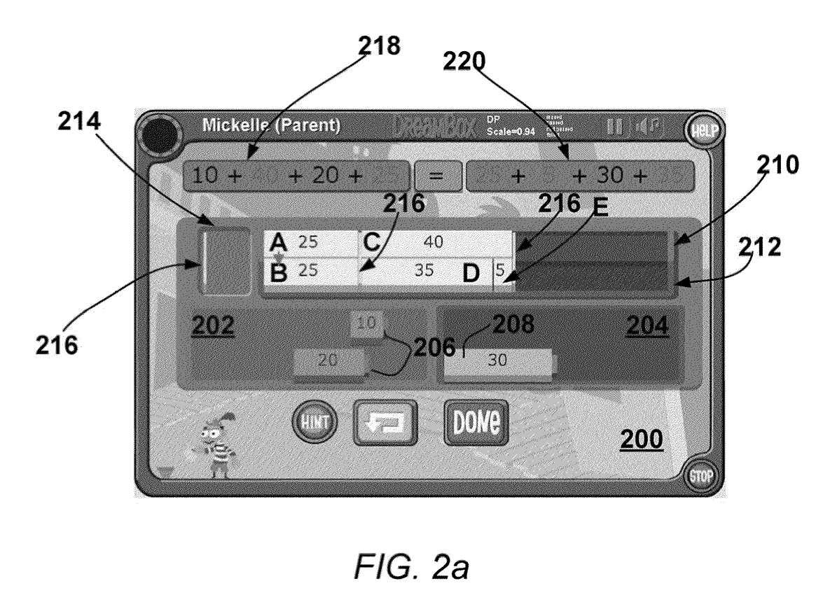

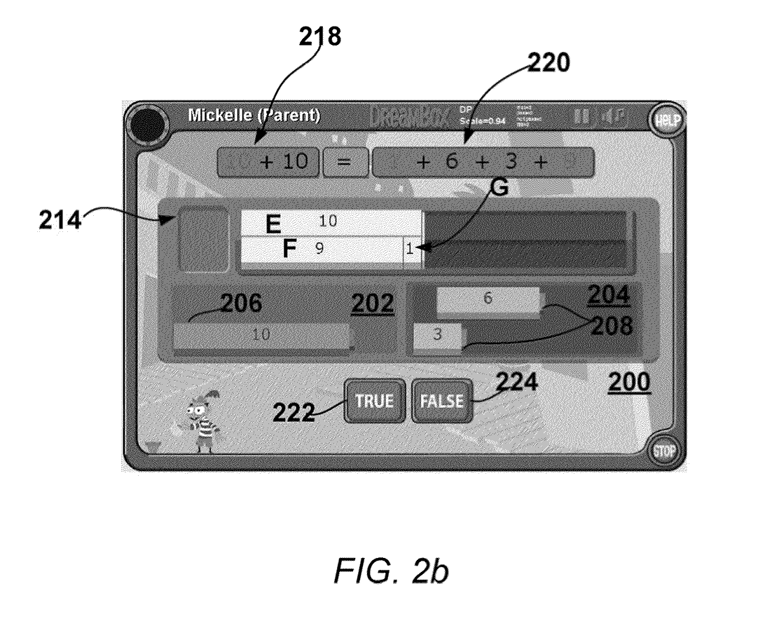

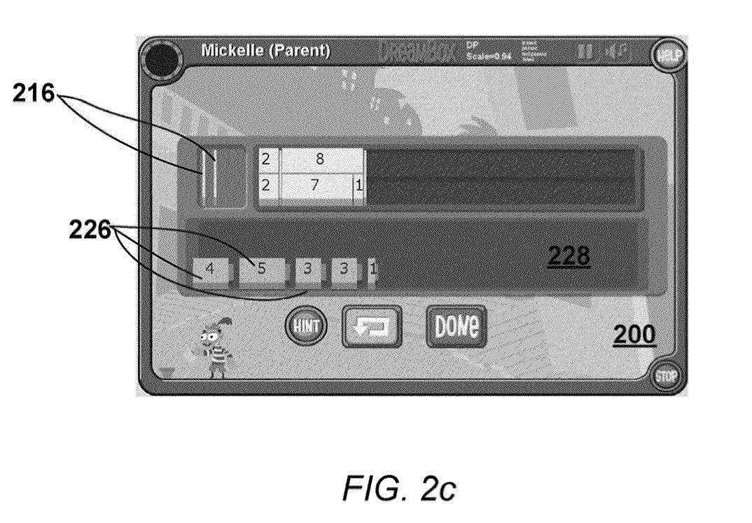

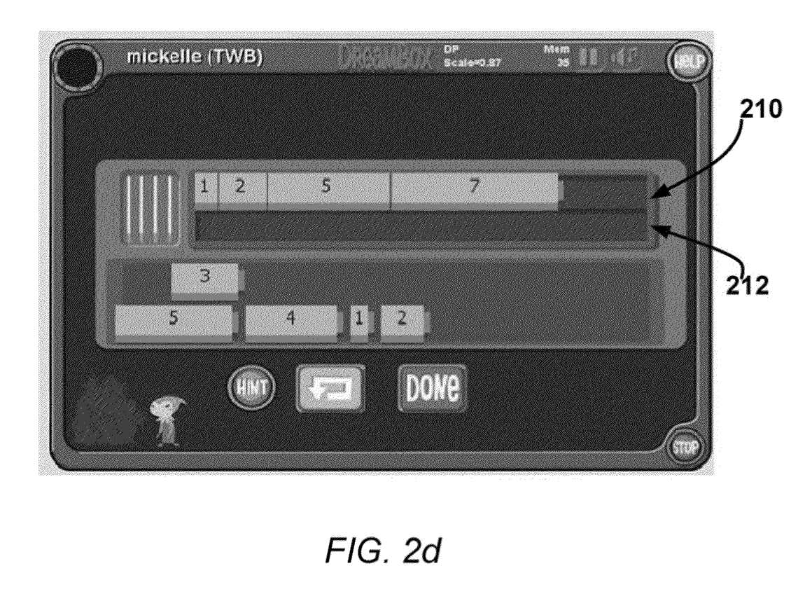

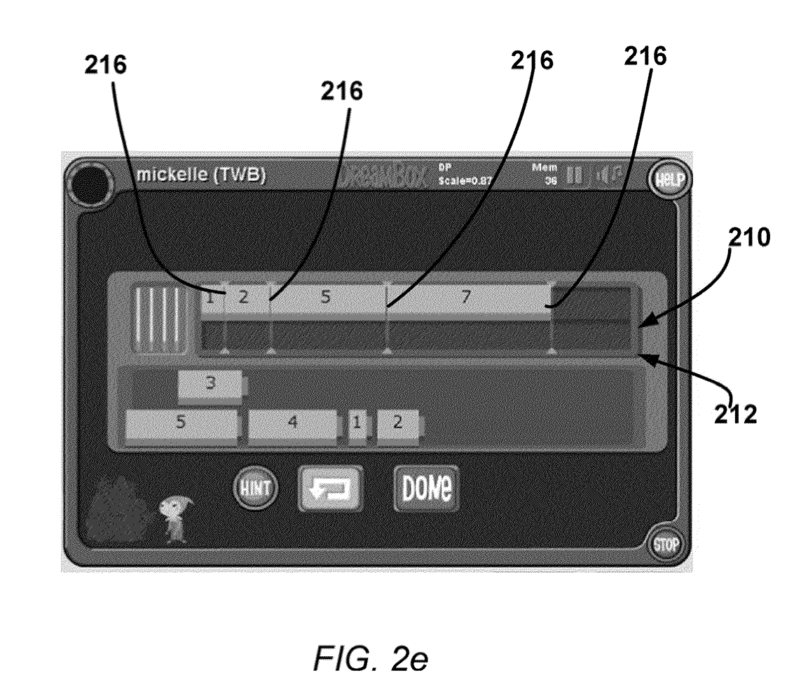

In accordance with another embodiment of the invention, there is provided a virtual manipulative 200 (see FIG. 2) called “snap blocks” designed to improve number sense. The manipulative 200 includes a first tray 202 and a second tray 204. As will be seen, the trays 202, 204 are positioned adjacent each other and are colored green and blue, respectively. The tray 202 is to hold a plurality of blocks 206. Each block 206 has a number marked thereon and has a linear dimension that is proportional or scaled to the value of that number. For example in the tray 202 one can see two blocks 206. The first block is marked with the number 20, whereas the second block is marked with the number 10. As the number 10 is twice the number 20 the block marked with the number 20 has a length that is twice the length of the block marked with the number 10. Thus, a learner is provided with a visual clue that the number 20 is twice the number 10. Likewise, the tray 204 holds blocks 208 which are similar to the blocks 206 except that they have a different visual appearance. Here, the blocks 208 visually different to the blocks 206 by color. Positioned above the trays 202, 204, the manipulative 200 includes two linear receptacles indicated by reference numerals 210 and 212. The receptacle 210 is for receiving blocks from the tray 202, whereas the receptacle 212 is for receiving blocks from the tray 204.

In one embodiment, a learner is required to find a block 206 or a combination of the blocks 206 that is numerically equivalent to a block 208 or a combination of the blocks 208. For example, the block marked A in the tray 210 is marked within the numerical value of 25. Likewise the block marked B in the tray 212 is marked within the numerical value of 25. Thus, the blocks A and B are numerically equivalent and are said to form an equivalency. To begin with, the block marked A would have been in the tray 202, whereas the block marked B would have been in the tray marked 204. The manipulative 200 provides a challenge to the learner which in this case is to form three combinations or groups that are numerically equivalent. To indicate the challenge, the area marked 214 initially includes three equivalency rods 216. Thus, the learner knows that the challenge or problem is to find three equivalencies using the blocks from the trays 202 and 204. In FIG. 2a, the learner has found two equivalencies. The first equivalency is between the block A and the block B as each of these blocks represent the number 25. The second equivalency is between a block marked C marked with the number 40 and a combination of blocks marked D and E representing the numbers 35 and 5, respectively. Initially, the blocks marked A and C would have been colored green as they originated from the tray 202. Likewise, the blocks marked B, D, and E would have been colored blue as they originated from the tray 204.

To arrive at the configuration shown in FIG. 2a, the learner would have first moved the blocks A and B into the position shown to form the first equivalency. Since the equivalency was correctly formed, the manipulative 200 would have transformed the colors of the blocks into a different color thereby to signify that the equivalency relationship exists. In the example shown in FIG. 2a of the drawings, the blocks marked A and B have been transformed to the color yellow. The manipulative 200 also moves an equivalency rod 216 from the area 214 to coincide with the right edge of the blocks A and B. This further signifies that an equivalency has been established. Likewise, placement of the blocks C, D, and E as shown in the FIG. 2a causes the colors of the blocks to change and moves equivalence rod 216 to the right edge of the combination of blocks C, D, and E. This signifies that the combination C, D, and E forms an equivalency.

In one embodiment, the numbers represented by the blocks provided in the tray 202 are indicated in the area 218 whereas the numbers represented by the blocks provided in the tray 204 are indicated in the area 220. When a block representing a number is placed in one of the trays 210, 212, that particular number is visually highlighted in the areas 218, 220 to signify that that number has been used. For example, in one embodiment, when an equivalency is formed using rod 214, all numbers in the areas 218 and 220 in that equivalency are colored gray.

The snap blocks virtual manipulative 200 may be used in different ways to facilitate learning. For example, referring to FIG. 2b, it will be seen that an equation is presented using the areas 218 and 220. Further, a “true” button 222 and a “false” button 224 are presented. The goal is for a learner to establish whether the equation is true or false. The learner may use the blocks provided in the trays 202, 204 to do this. For example, the learner may establish the equivalency between the number 10 on the one hand, and the numbers 9 and 1 on the other hand. To do this, blocks marked F, G, and H are placed in the trays 210, 212 as shown. This causes the number 10 on one side of the equation to be de-emphasized, and the numbers 1 and 9 on the other side of the equation to be de-emphasized. In one embodiment, de-emphasizing a number may be by displaying the number in a lighter shade. De-emphasizing the numbers used to form an equivalency in the manner described brings into focus the remaining numbers on both sides of the equation. Thus in the example shown in FIG. 2b, the number 10 on one side of the equation and the numbers 6 and 3 on the other side of the equation are brought into focus. At this stage the learner may use the remaining blocks to test whether the number 10 is equivalent to the numbers 6 and 3. Alternatively, the learner may realize that the number 10 is not equal to the numbers 6 and 3 without the use of the blocks. The learner then selects the button 224 to indicate that the equation is false.

With the embodiment of the snap blocks virtual manipulative 200 shown in FIG. 2c of the drawings, blocks 226 are all of a single color and displayed in a single tray 228. The learner is challenged to form a designated or specified number of equivalencies. The specified number is indicated by the number of equivalence rods 216.

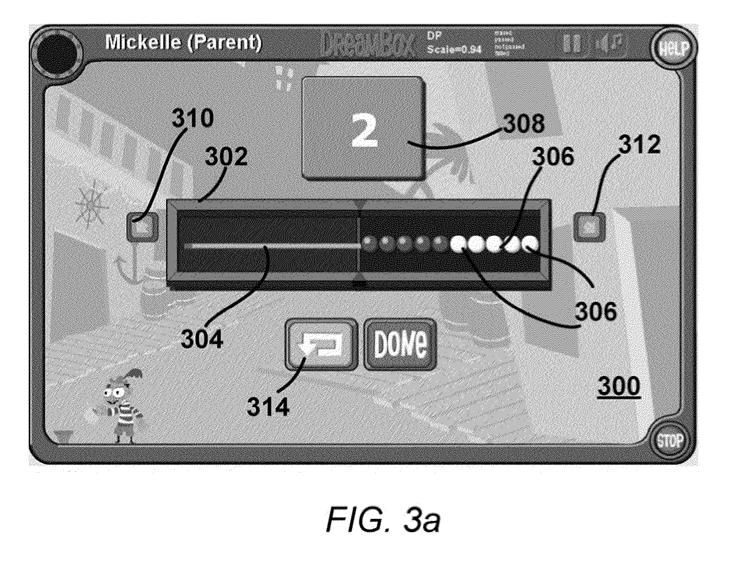

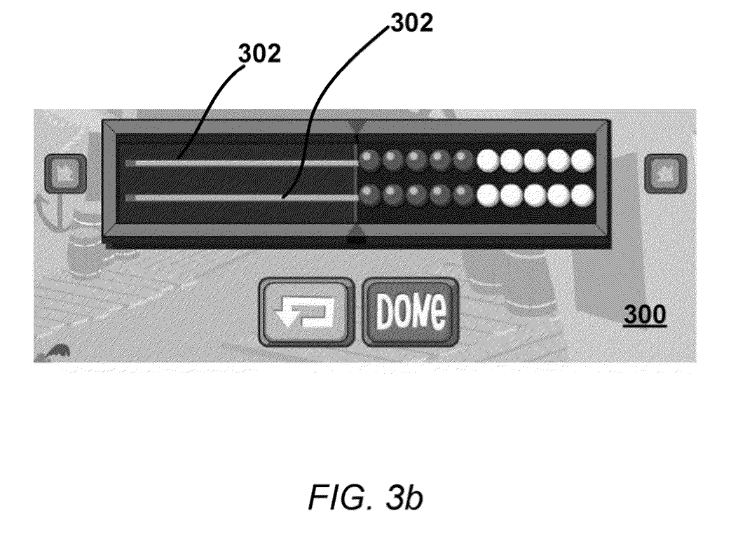

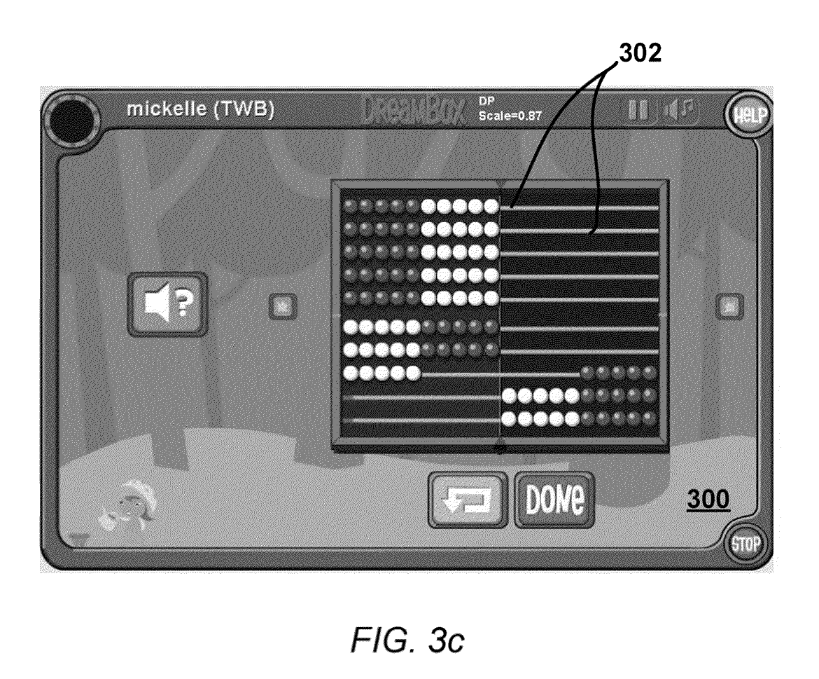

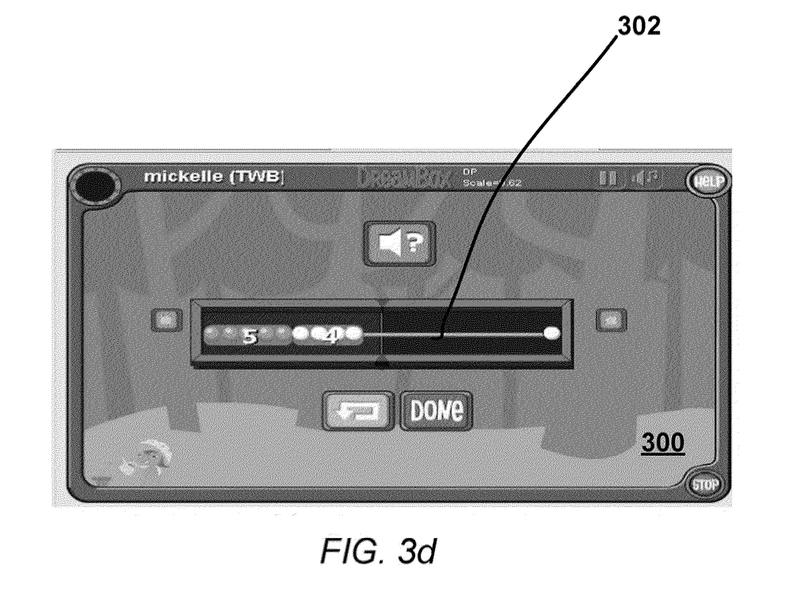

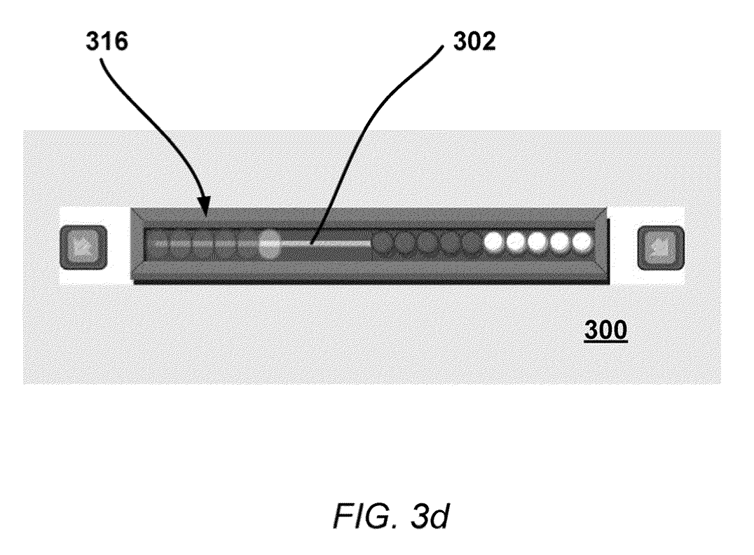

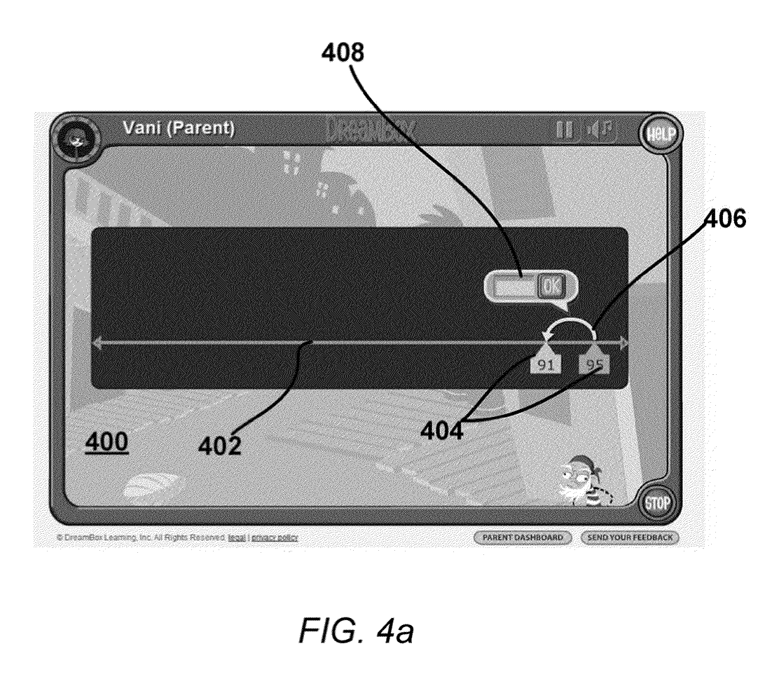

In one embodiment, the snap blocks virtual manipulative may provide assistance to a learner in the form of hints to assist in the placement of the blocks to form equivalencies. In one embodiment, the hints may include audio suggestions e.g. “Find two blocks that are the same length”. In another embodiment, the hints may be provided by having all the blocks of a single color and pre-populating one of the trays (e.g. the tray 210 in FIG. 2d, thus leaving the learner to populate only a single tray. In another embodiment, the hints may include outlining or “ghosting” the final position of the equivalency rods in the trays 210, 212 (see FIG. 2e). In accordance with another embodiment of the invention, there is provided a virtual manipulative 300 (see FIG. 3) known as a “math rack”. As will be seen, the manipulative 300 includes a frame 302 and at least one spindle 304 mounted within the frame 302. Each spindle has a left end, a right end, and a midpoint. The portion of the spindle from its left end to its midpoint defines a counting section, whereas the portion of a spindle between its midpoint and the right end defines a non-counting section. Beads or counters 306 are slidably positioned on each spindle 304. In one embodiment, the total number of beads 306 on a spindle may be 10 with 5 of the leftmost beads being differentiated from five of the rightmost beads, for example, based on color. The manipulative 300 may include a first control to select a number of beads 306 in the range from 1 to 10. In one embodiment, the first control comprises a pointing device such as a mouse. Selection of one or more beads 306 using the first control causes the selected beads to move from the non-counting section to the counting section of the spindle on which the beads are mounted. The beads may be used to represent a number by using the first control to move beads into or out of the counting section. In one embodiment, the manipulative 300 may challenge a learner to represent a number presented in a tile 308 using the beads 306. To solve the challenge, a learner uses the first control to move an appropriate number of beads 306 from the non-counting section of a spindle to the counting section.

In one embodiment, the virtual manipulative 300 also includes a tilt control mechanism which includes a left tilt button 310 and a right tilt button 312. Activation of the left tilt button 310 causes the frame 302 to be tilted in anti-clockwise direction thereby to move all beads 306 into the counting sections of their respective spindles 304. Likewise, activation of the right tilt button 312 causes the frame 302 to be rotated in a clockwise direction thereby to cause all beads 306 to be moved from the counting to the non-counting sections of their respective spindles 304. In one embodiment, the manipulative includes a reset button 314 to reset the manipulative so that all the beads are moved to the non-counting sections of their respective spindles.

Different embodiments of the virtual manipulative 300 may comprise different numbers of spindles 304. FIG. 3b shows an embodiment with two spindles 302 whereas FIG. 3c shows an embodiment with 10 spindles 302. It will be appreciated, that the math rack virtual manipulative may be used to improve the counting ability of learners. In one embodiment, the virtual manipulative 300 includes the capability to chunk numbers into optimal chunks, or groups of beads that are developmentally appropriate to each user. In early counting, users begin to see numbers in small groups as opposed to one and one and one, etc. In later counting, users see numbers in groups of ten and left-overs. For example, the number nine may be formed using a chunk of 5 beads and a chunk of 4 beads, whereas the number 4 may be forming using chunks of 5 and then removing 1 bead, respectively. Thus, when building the number 9, instead of tediously adding single beads to the counting section, a total of 5 beads may be selected and moved to the counting section as one chunk followed by total of 4 beads as other chunk. In one embodiment, the virtual manipulative 300 may provide visual clues or highlights to reinforce the relationship between a number and the “chunks” that make up the number. For example, referring to FIG. 3d of the drawings, there is shown the number 9 made up of two chunks comprising 5 beads and 4 beads. To reinforce the chunks, the first chunk of 5 is highlighted as a unit and the second chunk of 4 is highlighted as a unit. Further, chunk of 5 is labeled with the number 5 and the chunk of 4 is labeled with the number 4.

In one embodiment, the virtual manipulative 300 may support “ghosting” to assist a learner with placement of beads to form a number. With ghosting, an outline 316 (see FIG. 3d) indicative of the correct placement of the beads in the counting-section of a spindle is provided as a hint to a learner.

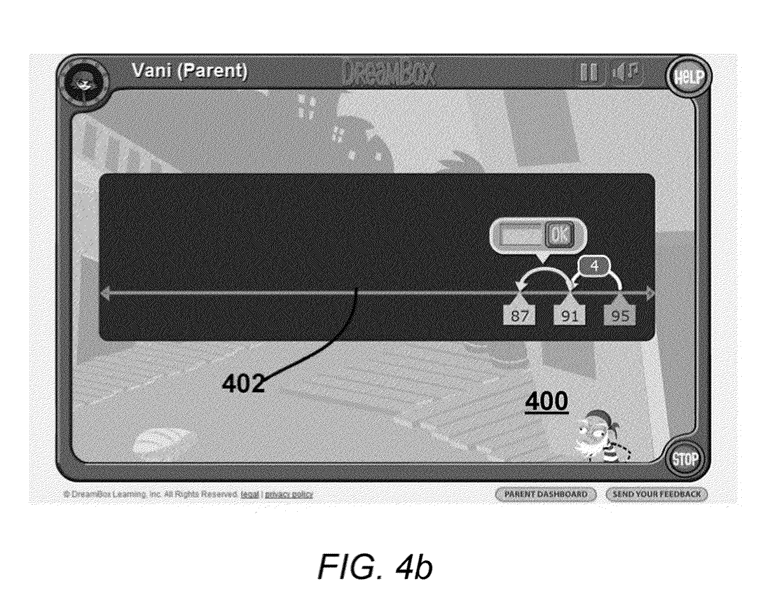

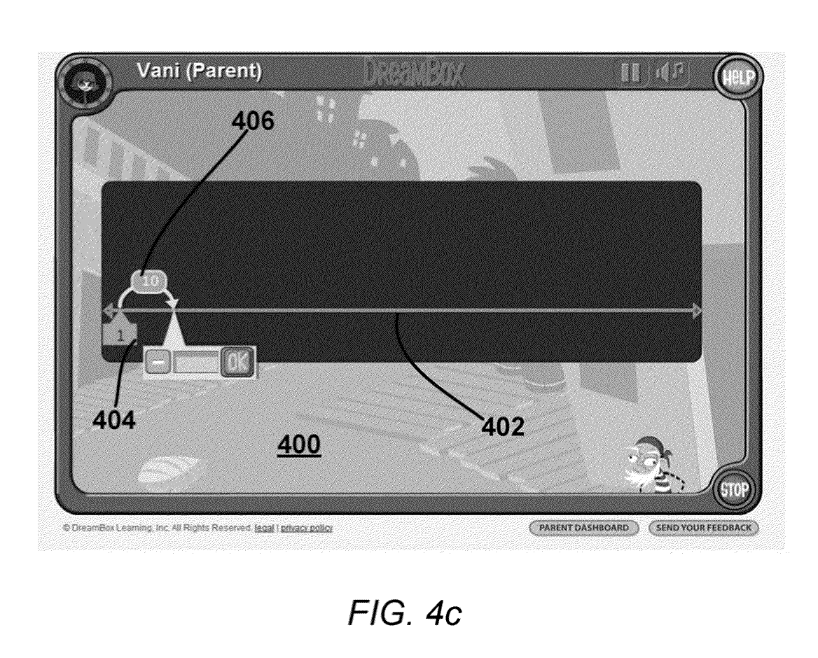

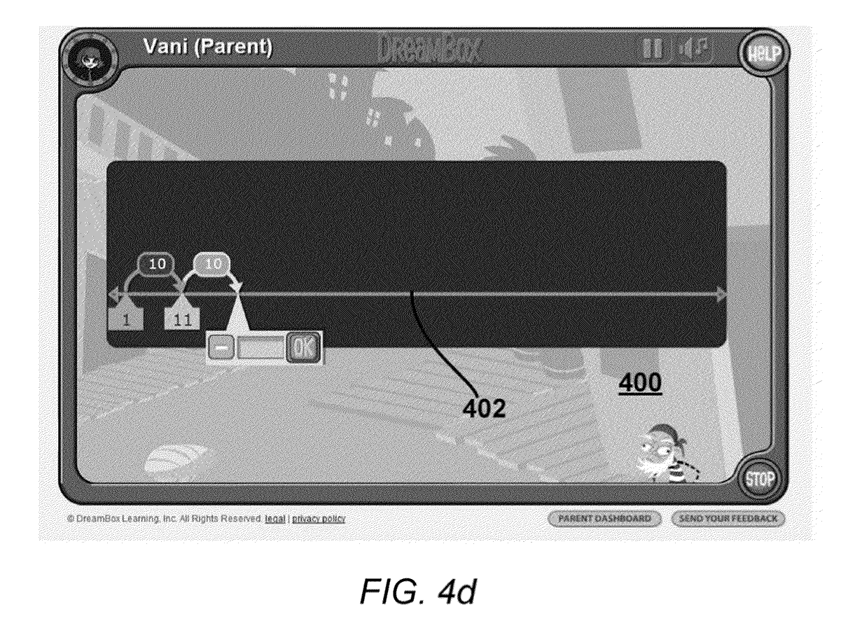

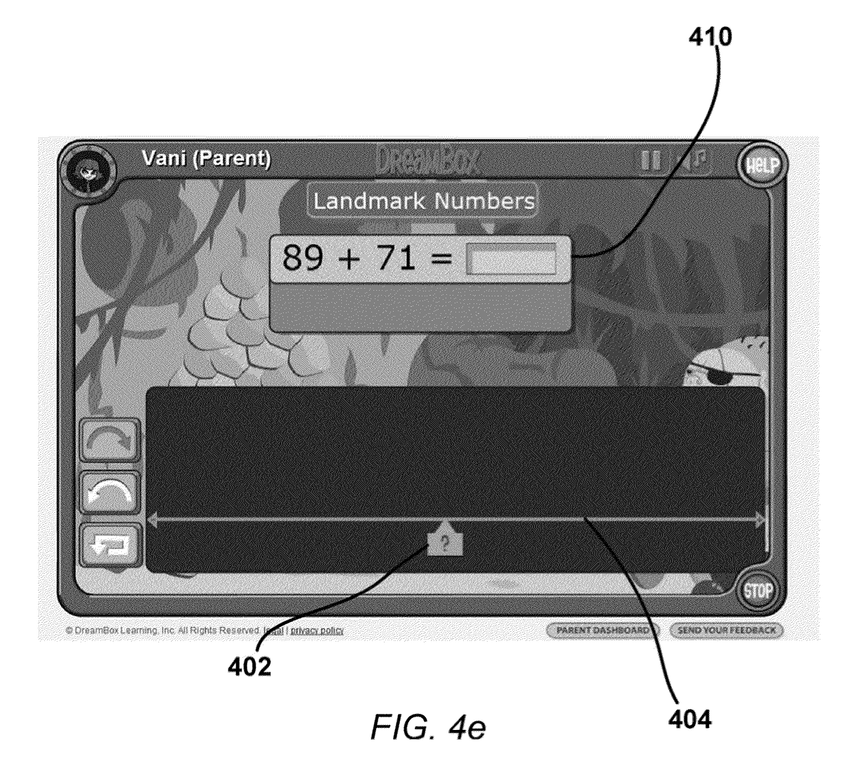

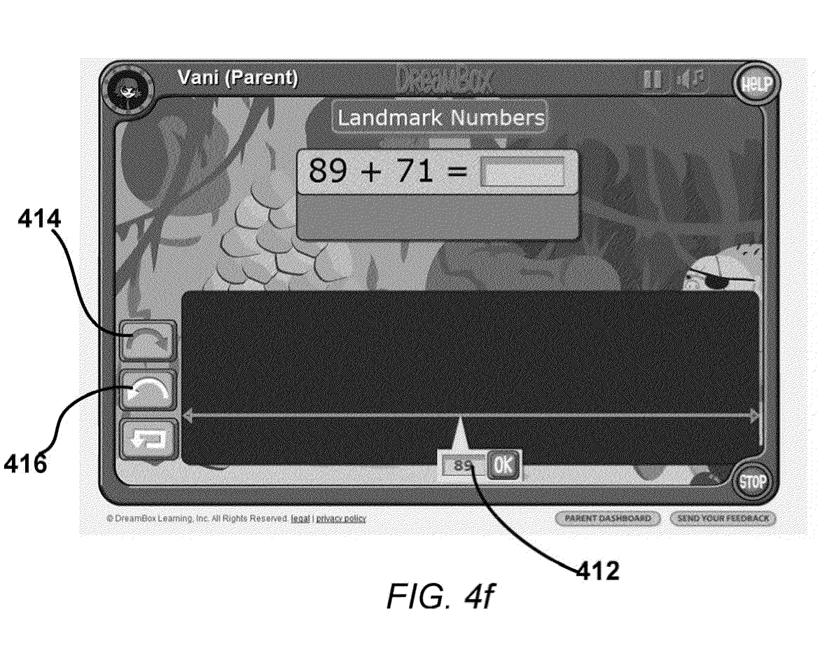

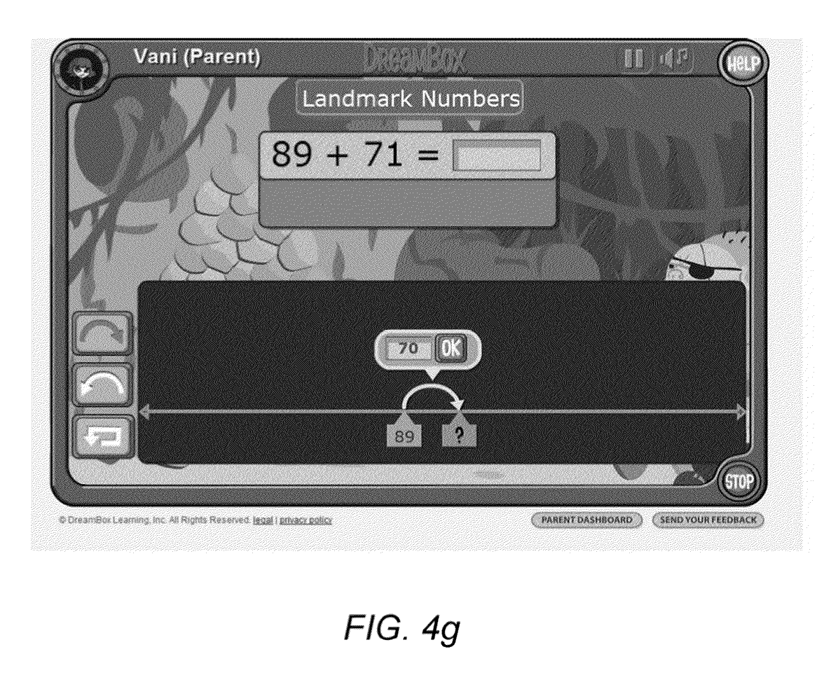

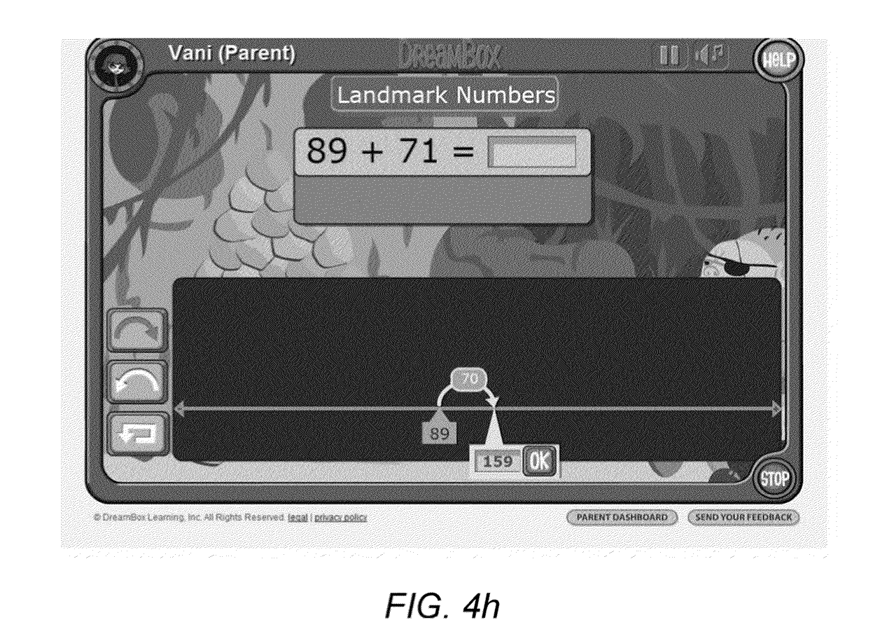

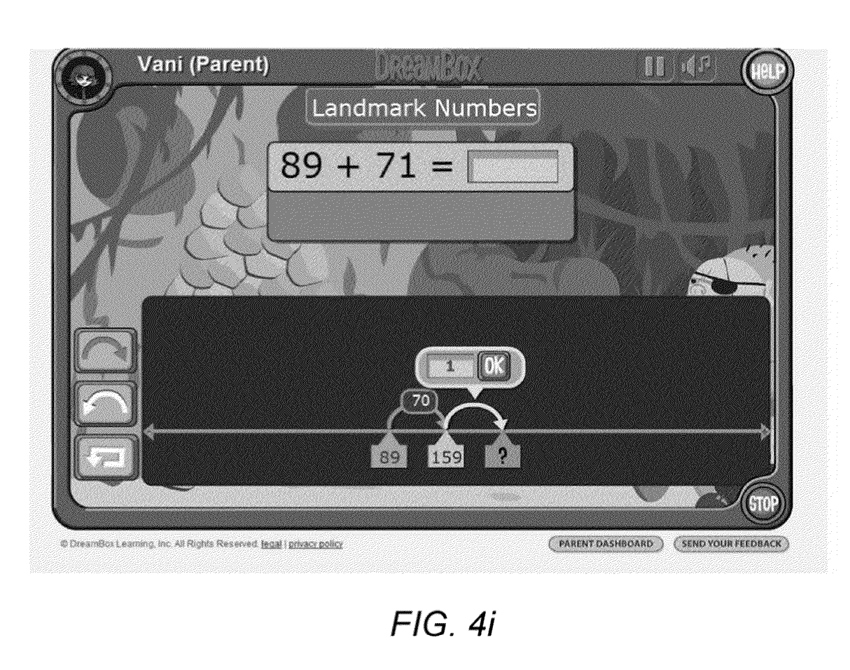

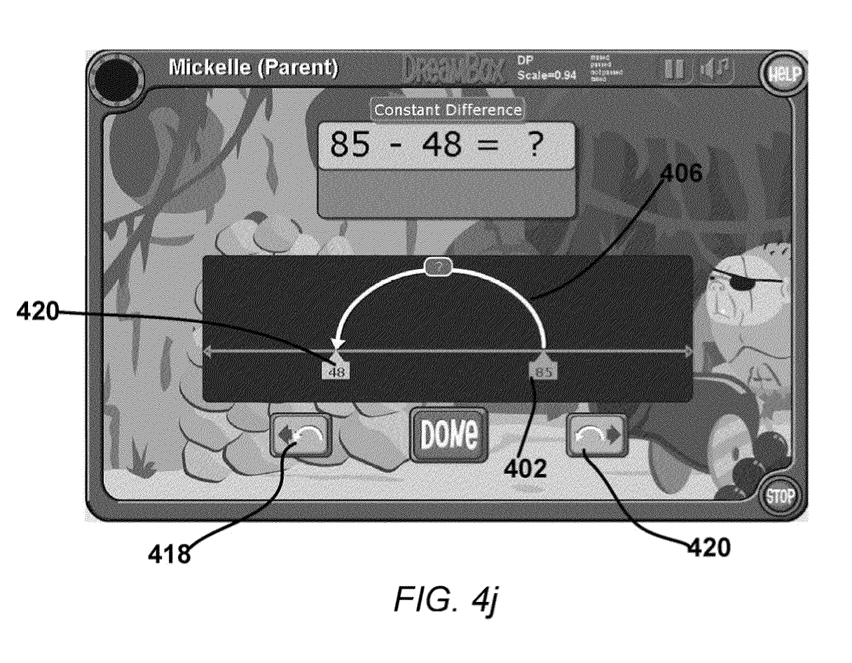

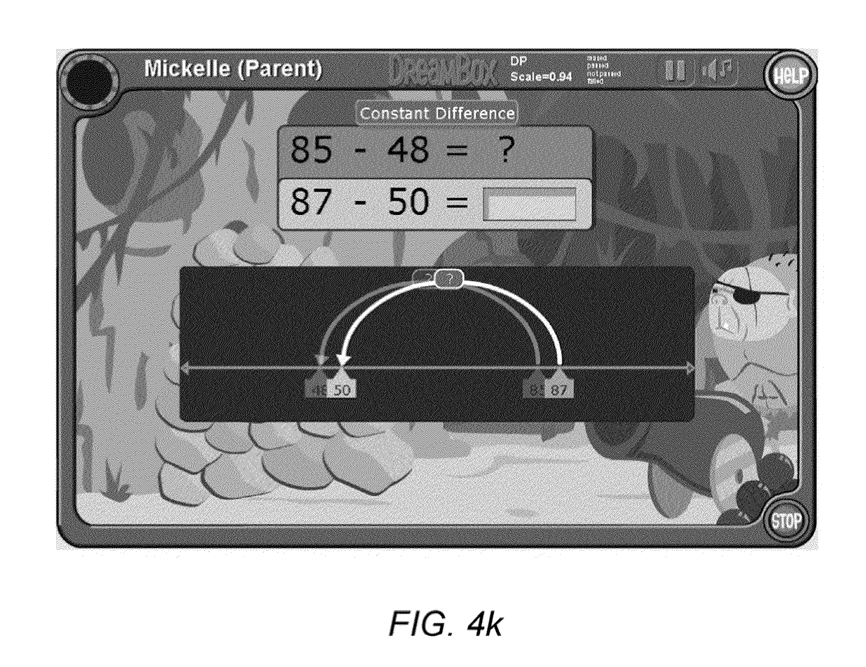

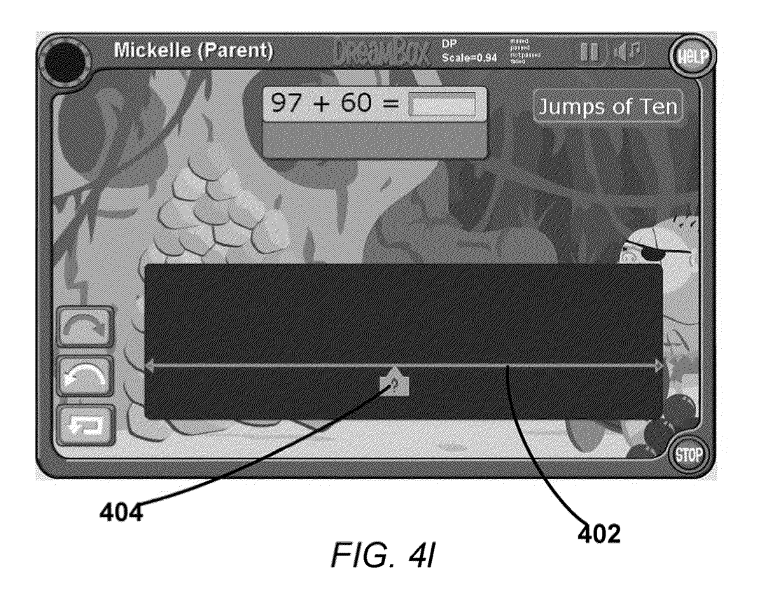

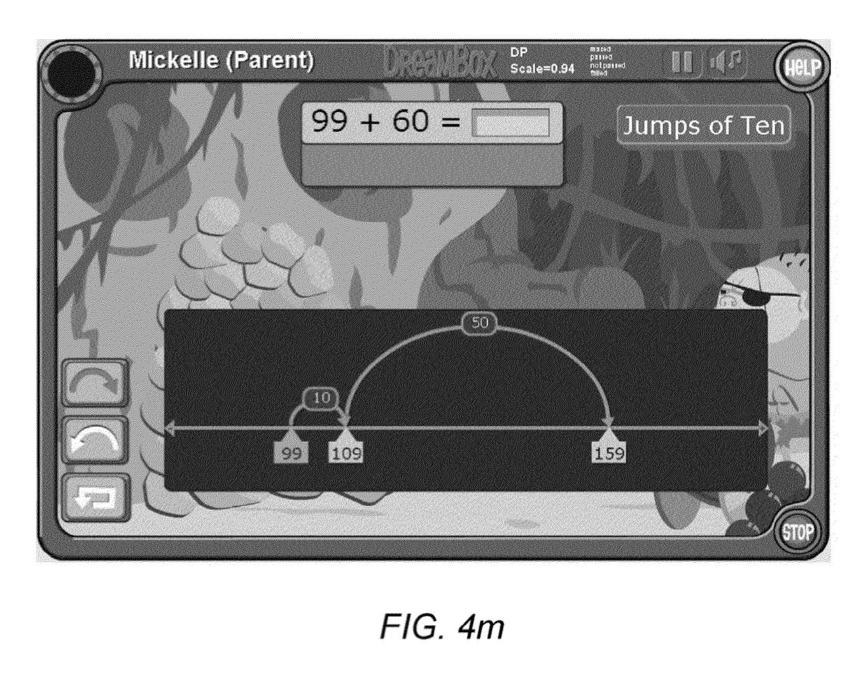

FIG. 4a of the drawings shows an embodiment of a virtual manipulative 400 known as an “open the number line”. The virtual manipulative 400 includes a horizontal line 402. In one embodiment, the line 402 may be scaled to represent numbers in the range 1 to 100, or any other range. The manipulative 400 may include markers 404 positioned adjacent the line 402 to indicate the relative position's of the numbers on the line. In the example shown in FIG. 4a the markers 404 are shown to indicate the relative positions of the numbers 91 and 95. As will be seen, the manipulative 400 also includes a spatial indicator 406 to indicate to the numerical distance between two markers. In the embodiment shown in FIG. 4a, the spatial indicator 406 is in the form of an arc-shaped arrow.

The virtual manipulative 400 may be used in various ways to provide an understanding of the numerical separation or spatial distance between numbers. For example, in one embodiment markers 404 mark two numbers along the line 402 and a learner is required to input the numerical spacing or “jump” between the two numbers. To assist the learner, the jump is indicated by the spatial indicator 408. The learner inputs a numeric value corresponding to the jump in box 408. This causes the numerical distance between the two numbers (4 in the case of the example shown) to be displayed on the indicator 406 (see FIG. 4b). Having successfully input a value for the jump, the manipulative 400 may mark a new number along the line 402 and require the learner to input the jump to the new number and any of the existing markers. In the example shown in FIG. 4b, the new number is 87 and the learner is required to enter the jump between the numbers 91 and 87.

FIG. 4c shows an embodiment of the virtual manipulative 400 where a first number (in this case the number 1) is marked of on the line 402 using a marker 404. A jump to another number on the line 402 is indicated by the spatial indicator 406 and a learner is required to calculate a “landing number” based on the first number and the jump value. The landing number is the sum of the first number and the jump value, or the difference, depending on the direction of the jump. In the case of the example of FIG. 4c the jump value is 10 and the direction is to the right of the first number. Thus, the landing number is 11. Once the landing number is input, the manipulative may require the learner to calculate another landing number based on the previous landing number and a new or the same jump value (see FIG. 4d). This may be repeated several times.

In the example of the manipulative 400 shown in FIG. 4e, a learner is presented with a problem to solve in box 410. To assist with the solution to the problem, the learner is provided with a line 402 and an unassigned marker 404 positioned along the line 402. If the learner decides to solve the problem using line 402 then the user is required to click on the marker 404 to assign a number to the marker. Clicking on the marker 404 causes a box 412 to be displayed to allow input of the number to be assigned to the marker 404. In the example shown (see FIG. 4f), the learner enters the number 89 for assignment to the marker 404. As will be seen, the virtual manipulative 400 includes a right jump control button 414 and a left jump control button 416. The button 414 is used to make jumps to the right of a number, whereas the button 416 is used to make jumps to the left of the number. To solve the problem shown in FIG. 4e the learner may wish to add a “landmark” number to the number 89 instead of the number 71. A landmark number is a number that is easy to add, e.g. a number that is a multiple of 10. In the present case, the learner inputs the landmark number 70 as a jump value to be added to the number 89 (see FIG. 4g). Responsive to input of the jump value of 70, the virtual manipulative 400 requires input of the landing number corresponding to the jump. In this case, the landing number is the number 159 (see FIG. 4h). At this point the learner may mentally add 1 to 159 to arrive at the answer 160. Alternatively, the learner may use the button 414 to enter a jump to the right with a jump value of 1 as an intermediate step to arriving at the answer of 160. This is shown in FIG. 4i of the drawings.

One skilled in the art would appreciate that the virtual manipulative 400 may be using a variety of ways to solve problems of addition and subtraction. To illustrate how flexible and powerful the virtual manipulative 400 can be, consider FIG. 4j where a learner is presented with the problem of calculating the difference between the numbers 85 and 48. To assist the learner in calculating the distance, the numbers 48 and 85 are marked using markers 404 on the line 402 and the numerical distance or jump between the numbers 48 and 85 is indicated by the numerical indicator 406. The learner may feel that solving the problem 85−48 is too difficult and may wish to change the numbers in the problem to make the problem easier. To do this, the virtual manipulative 400 includes a shift down control 418 and a shift up control 420, as can be seen in FIG. 4j. Activation or selection of the shift down control 418 causes the markers representing the numbers 48 and 85 to be moved to the left along the line 402 in sympathy or in concert with each other by a numerical distance corresponding to one number. Likewise, activation or selection of the control 420 causes the markers representing the numbers 48 and 85 to be moved in sympathy with each other to the right along the line 402 by the numerical distance of a single number. For the example given in FIG. 4j, clicking the button 420 twice causes the markers to be shifted to the right along the 402 a distance of 2 numbers. Thus the markers now represent the numbers 50 and 87, as can be seen in FIG. 4k. One skilled in the art would appreciate that the above-described shifting process using the controls 418,420 preserves the original spacing or difference between the numbers. A learner may find it easier to compute 87 minus 50 as 50 is a multiple of 10. The user can still see a dimmer version of the original arc.

In the example shown in FIG. 41 a learner is required to solve the problem 97+60. To assist the learner, a line 402 and an unassigned marker 404 are provided. To solve the problem, the learner can assign any number to the marker 404 and then initiate a series of jumps to assist in the computation of the answer. For example, as is shown in FIG. 4m, the learner assigned the number 99 the marker and initiated a jump to the right along the line 402 corresponding to a jump value of 10. Thereafter, the learner records the landing number 109 being the sum of 99 and the jump value of 10. To complete the solution, the learner initiates a further jump using a jump value of 50 to arrive at the answer 159. Thus, the virtual manipulative 400 may be used to simplify addition or subtraction using a series of jumps.

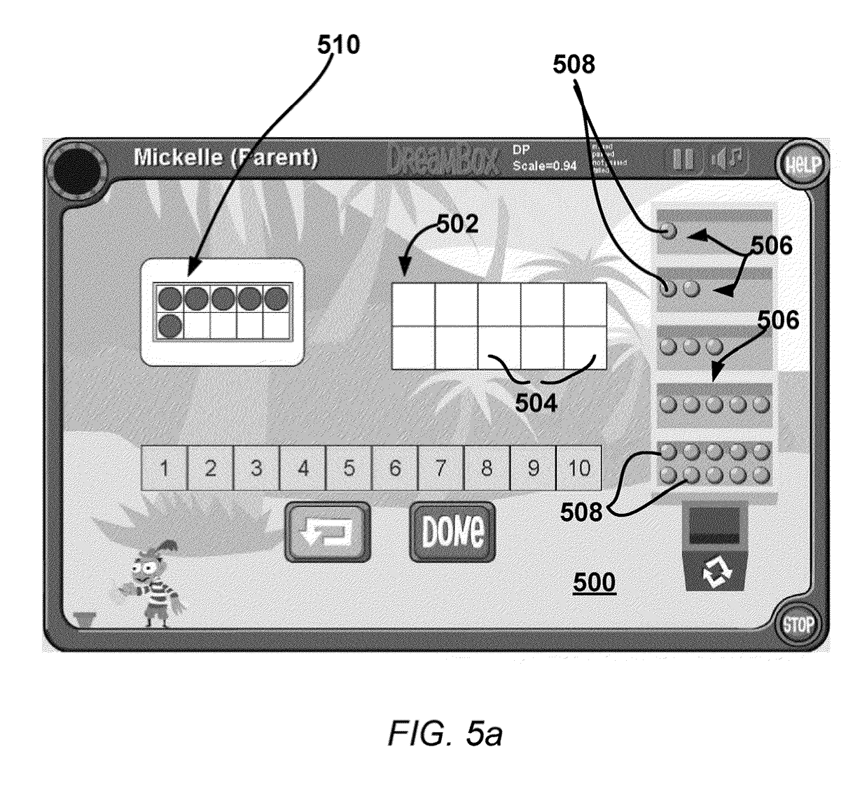

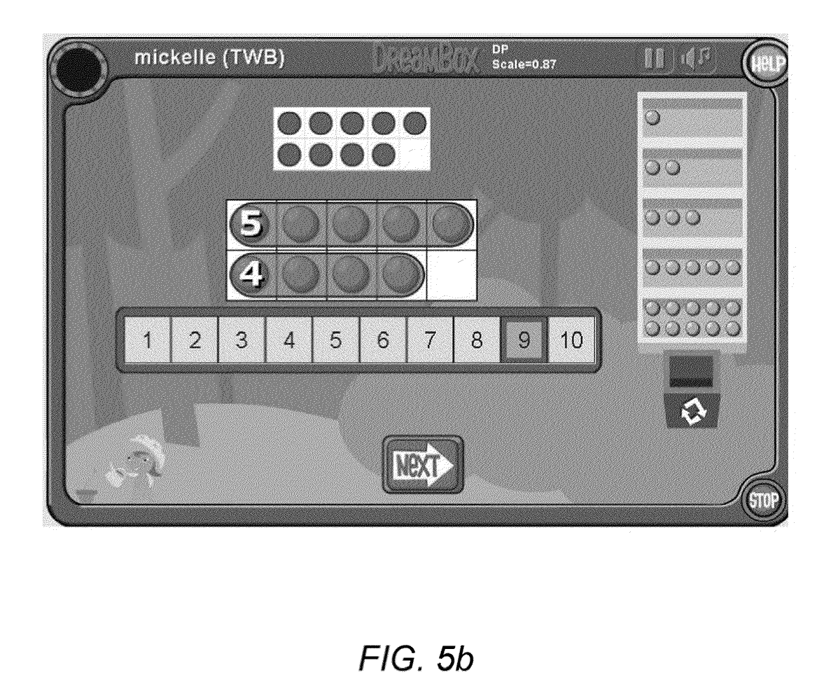

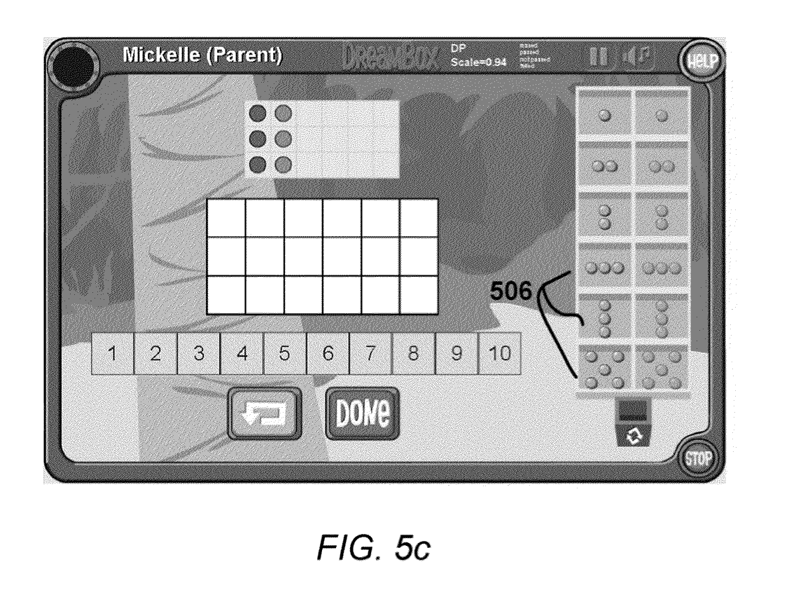

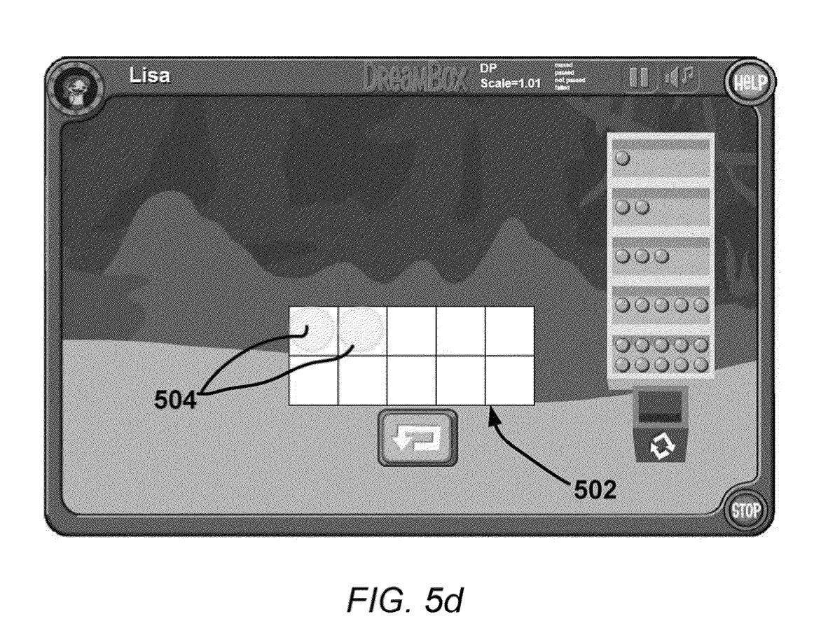

A “numbergram” is a visual presentation of a number using counters rather than numeric characters. Referring now to FIG. 5a of the drawings, there is shown an embodiment 500 of a virtual manipulative that uses numbergrams As will be seen, the manipulative 500 includes a first area displaying a frame 502 comprising a number of slots 504 for holding counters. Further, the manipulative 500 includes a plurality of numbergrams 506. Each numbergram 506 represents a number comprising a set of graphical counters 508. Advantageously, each numbergram is easily subitizable by a learner. As used herein, the term “subitizable” means that the particular number that a numbergram is intended to represent may be discerned from the configuration of the counters in the numbergram without having to resort to actual counting of the counters on a one-by-one basis. The virtual manipulative 500 also includes a control whereby numbergrams may be selected and moved into the slots 504 of the frame 502. In one embodiment, a learner is required to build a specified number by moving appropriate numbergrams into the frame 502. The specified number may be indicated by a counters in a frame 510. The control has the ability to chunk numbers, or show groups of beads in developmentally appropriate sets. For example consider FIG. 5b which shows an example where a learner is required to form the number 9 using the number grams provided. The solution shows that the number 9 can be composed of two chunks, namely, a first chunk comprising five counters, and a second chunk comprising four counters. Further, chunk of 5 is labeled with the number 5 and the chunk of 4 is labeled with the number 4.

Referring to FIG. 5c of the drawings, there is shown embodiments of the numbergram virtual manipulative 500 wherein numbergrams 506 comprising different counter configurations for easy subitization can be seen.

Some embodiments of the virtual manipulative 500 may support ghosting. With ghosting, a hint is provided to a learner by indicating on the frame 502 the pattern of the number gram that a learner is to use. For example consider FIG. 5d where two the slots 504 are marked with yellow circles to indicate that a learner should use the number gram corresponding to the number 2.

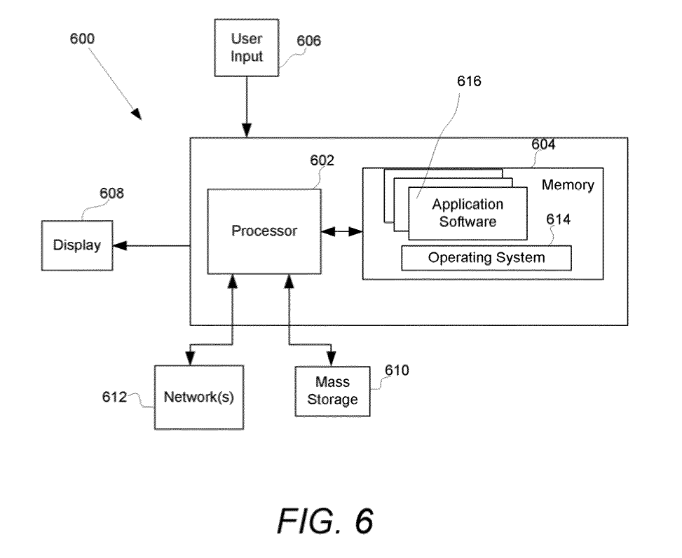

Each of the virtual manipulatives and tools described above may be generated on a computer system. FIG. 6 of the drawings shows an example of a computer system 600. The system 600 may be operable to generate each of the above described virtual manipulatives. The system 600 may include at least one processor 602 coupled to a memory 604. The processor 602 may represent one or more processors (e.g., microprocessors), and the memory 604 may represent random access memory (RAM) devices comprising a main storage of the system 600, as well as any supplemental levels of memory e.g., cache memories, non-volatile or back-up memories (e.g. programmable or flash memories), read-only memories, etc. In addition, the memory 604 may be considered to include memory storage physically located elsewhere in the system 600, e.g. any cache memory in the processor 602 as well as any storage capacity used as a virtual memory, e.g., as stored on a mass storage device 610.

The system 600 also typically receives a number of inputs and outputs for communicating information externally. For interface with a user or operator, the system 600 may include one or more user input devices 606 (e.g., a keyboard, a mouse, imaging device, etc.) and one or more output devices 608 (e.g., a Liquid Crystal Display (LCD) panel, a sound playback device (speaker, etc)).

For additional storage, the system 600 may also include one or more mass storage devices 610, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 600 may include an interface with one or more networks 612 (e.g., a local area network (LAN), a wide area network (WAN), a wireless network, and/or the Internet among others) to permit the communication of information with other computers coupled to the networks. It should be appreciated that the system 600 typically includes suitable analog and/or digital interfaces between the processor 602 and each of the components 604, 606, 608, and 612 as is well known in the art.

The system 600 operates under the control of an operating system 614, and executes various computer software applications, components, programs, objects, modules, etc. to implement the techniques described above. Moreover, various applications, components, programs, objects, etc., collectively indicated by reference 616 in FIG. 6, may also execute on one or more processors in another computer coupled to the system 600 via a network 612, e.g. in a distributed computing environment, whereby the processing required to implement the functions of a computer program may be allocated to multiple computers over a network. The application software 616 may include a set of instructions which, when executed by the processor 602, causes the system 600 to generate the virtual manipulatives described.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others.

Although the present invention has been described with reference to specific example embodiments, it will be evident that various modifications and changes can be made to these embodiments without departing from the broader spirit of the invention. Accordingly, the specification and drawings are to be regarded in an illustrative sense rather than in a restrictive sense.

1. A method, comprising:
displaying a list of addends for a learner to add;
providing a first empty column to receive a revised addend list input by the learner, wherein at least some of the addends in the revised addend list are partial sums or decompositions of selected addends from the list of addends;
receiving said revised addend list as input from the learner;
providing a control to add at least one second empty column at the instance of the learner, each second empty column to receive a further revised addend list input by the learner, wherein at least some of the addends in the further revised addend list are partial sums or decompositions of selected addends from the revised addend list that was input last;
receiving each further revised addend list as input by the learner; and
receiving an answer from the learner corresponding to a sum of all addends in the last-added revised addend list.

2. The method of claim 2, wherein the first and second empty columns are arranged from left to right.

3. The method of claim 1, further comprising providing a selection tool to allow the learner to select the selected addends.

4. The method of claim 3, wherein the selection tool highlights the selected addends after they have been selected and before the partial sum corresponding to the addends is received.

5. The method of claim 4, further comprising visually indicating the addends associated with a partial sum.

6. A system, comprising a
a processor; and
a memory coupled to the processer, the memory storing instructions which when executed by the processor causes the system to perform a method comprising:
displaying a list of addends for a learner to add;
providing a first empty column to receive a revised addend list input by the learner, wherein at least some of the addends in the revised addend list are partial sums or decompositions of selected addends from the list of addends;
receiving said revised addend list as input from the learner;
providing a control to add at least one second empty column at the instance of the learner, each second empty column to receive a further revised addend list input by the learner, wherein at least some of the addends in the further revised addend list are partial sums or decompositions of selected addends from the revised addend list that was input last;
receiving each further revised addend list as input by the learner; and
receiving an answer from the learner corresponding to a sum of all addends in the last-added revised addend list.

7. The system of claim 6, wherein the first and second empty columns are arranged from left to right.

8. The system of claim 6, wherein the method further comprises a selection tool to allow the learner to select the selected addends.

9. The system of claim 8, wherein the selection tool highlights the selected addends after they have been selected and before the partial sum corresponding to the addends is received.

10. The system of claim 6, wherein the method further comprises visually indicating the addends associated with a partial sum.

11. A computer-readable medium having stored thereon a sequence of instructions which when executed on a system causes the system to perform a method, comprising:
displaying a list of addends for a learner to add;
providing a first empty column to receive a revised addend list input by the learner, wherein at least some of the addends in the revised addend list are partial sums or decompositions of selected addends from the list of addends;
receiving said revised addend list as input from the learner;
providing a control to add at least one second empty column at the instance of the learner, each second empty column to receive a further revised addend list input by the learner, wherein at least some of the addends in the further revised addend list are partial sums or decompositions of selected addends from the revised addend list that was input last;
receiving each further revised addend list as input by the learner; and
receiving an answer from the learner corresponding to a sum of all addends in the last-added revised addend list.

12. The computer-readable medium of claim 11, wherein the first and second empty columns are arranged from left to right.

13. The method of claim 11, wherein the method further comprises providing a selection tool to allow the learner to select the selected addends.

14. The computer-readable medium of claim 13, wherein the selection tool highlights the selected addends after they have been selected and before the partial sum corresponding to the addends is received.

15. The computer-readable medium of claim 11, wherein the method further comprises visually indicating the addends associated with a partial sum.
